(19) United States
(12) Patent Application Publication
(10) Pub. No.: US 2008/0111463 A1
(43) Pub. Date: May 15, 2008

(54) Backlight Source Structure Of Field Emission Type LCD

(76) Inventor: Chih-Che Kuo, Taipei City (TW)

Correspondence Address: HDSL, 4331 STEVENS BATTLE LANE, FAIRFAX, VA, 22033, US

(21) Appl. No.: 11/559,721

(22) Filed: Nov. 14, 2006

(51) Int. Cl. H01J 63/04; H01J 1/62

(52) U.S. Cl. 313/495; 313/496; 313/497

(57) ABSTRACT

A field-emission-typed backlight source structure for liquid crystal panel includes a cathode plate and an anode plate. The cathode plate is connected correspondingly to the anode plate. The cathode plate has a cathode substrate, on which a cathode unit is arranged. The cathode unit is shown as comb-shaped structure and further includes a cathode electrode layer and a gate electrode layer, both of which are coplanar on the cathode substrate, and at an intercrossing position with respect to both which an insulating layer is vertically overlapped to separate two layers. The anode plate further includes an anode unit, which is corresponded to the cathode unit, by the comb-shaped structure of which a matrix area is formed, whereby a luminance contrast is independently provided to the corresponding liquid crystal panel area.

### BACKGROUND OF THE INVENTION

1. Field of the Invention

The present invention relates to a liquid crystal display technology, in particular, to a liquid crystal display device applying matrix control as backlight source.

2. Description of Prior Art

Not only the picture quality shown by the liquid crystal display (LCD) developed currently has the ability to generate higher resolution and more colorful image than traditional display, but also the LCD can be designed as a thinner, lighter, more portable, more environment-protecting, and more power-saving structure, such that LCD can be widely applied to various electronic display devices.

However, because the liquid crystal material in common LCD can not emit light by itself, an external light source must be arranged behind the liquid crystal material as backlight source, in order to provide a light source that can make the liquid crystal material become lighting situation. Wherein, two filters and one liquid crystal layer may be applied to modulate the backlight source uniformly. The actuating principle of the backlight source is as follows. After being filtered by the first filter and being refracted by the liquid crystal molecule, light passes through liquid crystal layer, then after being filtered by the second filter, the light is emitted out and is finally incident upon the panel comprised of liquid crystal material.

However, liquid crystal displaying panel is not made of material that is totally transparent, so its transmittance is usually between 3%˜8% around. Even when pixel is completely switched to illumination, the light generated by backlight source is still absorbed in most part. Since most light is absorbed and can not pass through panel, so the luminance of pixel is insufficient. On the other hand, when pixel is switched to complete darkness, light leaks and emits out of panel, because the electrode controlling the rotation of liquid crystal can not be closed completely. Thereby, pixel can't be situated in total darkness, so its shadow contrast is insufficient. This is the so-called “low dynamic range” phenomenon of LCD. In here, dynamic range is defined as the ratio between highest luminance and lowest luminance. When the ratio is large (i.e., within high dynamic range), it means that the LCD's shadow contrast ratio is high. If this ratio is small (i.e., within low dynamic range), it means that the LCD's shadow contrast ratio is low. Common LCD is restrained by its low dynamic range, so its quality performance of screen picture can not reach ideal requirement in some high level applications.

Since dynamic range is one important factor that relates to the picture quality of LCD, so in order to promote LCD's dynamic range, there are two kinds of common techniques: the first one is the improvement of the structure and material of liquid crystal panel, and the other one is the improvement of the design of backlight source. However, the effect of improving the liquid crystal material is quite limited, and its technique level and expenditure cost are high as well. Relatively, it is one effective and economic choice to promote the contrast ratio shown by the entire LCD directly through backlight source, so a concept of LCD with high dynamic range is conceived.

The so-called “LCD with high dynamic range” is to take liquid crystal panel as a filtering structure. For example, it is assumed that a LCD's dynamic range is c:1. When a dynamic range of c2:1 backlight is used to compensate the LCD's dynamic range, the new LCD's dynamic range will be the multiplication of two values in theory, that is, (c1*c2):1. Therefore, some dealers, according to aforementioned concepts, propose plural light emission diodes (LEDs) formed as a matrix for the backlight source of LCD, through dynamic compensation to reach the effect of enhancing the dynamic range of LCD. However, corresponding to the increasing size of panel, the area of backlight board is increased, so is the quantity of LED. Furthermore, since the manufacturing method of LED is difficult, the manufacturing cost is increased significantly. In the meantime, if the quantity of LED is increased abruptly, it is further difficult to solve the problem of high heat dissipation thereof.

Accordingly, the problem desired to be solved by the dealer is how to effectively replace the structure of LED to make LCD have the effect of high dynamic range.

### SUMMARY OF THE INVENTION

With respect to above shortcomings, the main objective of the present invention is to provide a backlight source structure of field emission type constructed by triple electrodes. For each corresponding pixel of liquid crystal panel (LCD), not only the comb-shaped structure of cathode units arranged on the cathode plate independently provides the needed luminance contrast, but also a reflecting layer is further applied to reflect its generated light source for the enhancement of the light transmittance of LCD.

In order to achieve aforementioned objectives, the present invention provides a field-emission-typed backlight source structure for liquid crystal panel, which is mainly comprised of a cathode plate and an anode plate, wherein the cathode plate is connected correspondingly to the anode plate. The cathode plate has a cathode substrate, on which a cathode unit is arranged. The cathode unit is shown as comb-shaped structure and further includes a cathode electrode layer and a gate electrode layer, both of which are coplanar on the cathode substrate, and at an intercrossing position with respect to both which an insulating layer is vertically overlapped to separate two layers. The anode plate further includes an anode unit, which is corresponded to the cathode unit, by the comb-shaped structure of which a matrix area is formed, whereby a luminance contrast is independently provided to the corresponding liquid crystal panel area.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a sectional view of the structure according to the present invention;

FIG. 2 is a perspective view of the partial structure of the cathode plate according to the present invention;

FIG. 3 is a partial section view of the cathode plate according to the present invention;

FIG. 4 is an applying illustration according to the present invention; and

FIG. 5 is an operational illustration according to the present invention.

### DETAILED DESCRIPTION OF THE INVENTION

In cooperation with attached drawings, the technical contents and detailed description of the present invention will be as follows.

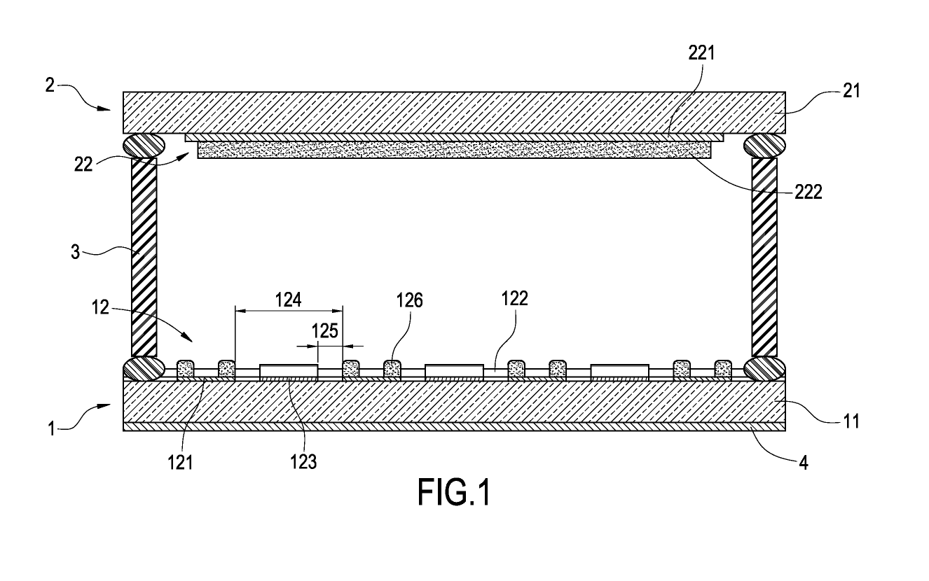

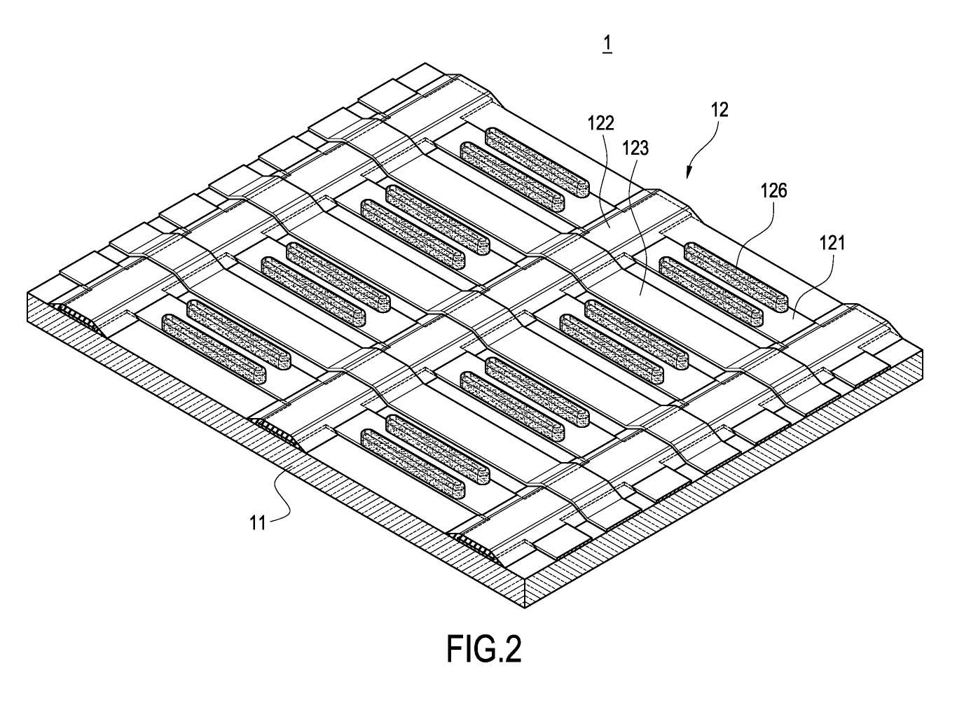

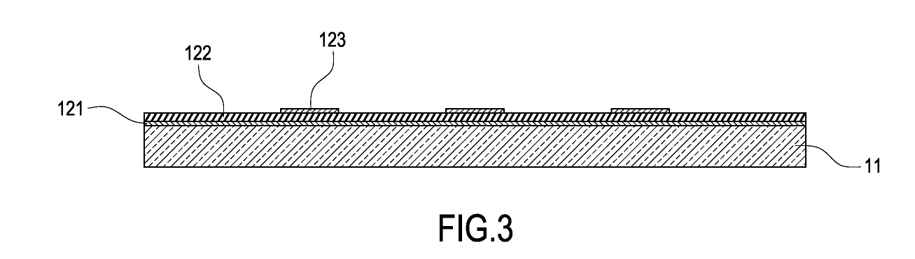

Please refer to FIG. 1 through FIG. 3, which separately are structural section view, perspective view of the partial structure of cathode plate, and partial section view of cathode plate according to the present invention. As shown in these drawings, the backlight source structure according to the present invention is a field emission structure of triple electrodes. The structure includes: a cathode plate 1, an anode plate 2, and a spacer 3, wherein the cathode plate 1 and the anode plate 2 are constructed correspondingly. The cathode plate 1 is mainly comprised of a cathode substrate 11, which is made of transparent glass, and on one plate surface of which a cathode unit 12 is arranged, and the cathode unit 12 further includes a cathode electrode layer 121, an insulating layer 122, and a gate electrode layer 133. In this embodiment, the stripes of cathode electrode layer 121 are crisscrossed to form as comb-shaped structure in vertical and parallel directions. As shown in the perspective enlargement view of FIG. 2, a space 124 is formed between any two parallel stripes of cathode electrode layer 121, which is formed as comb-shaped structure made of indium tin oxide (ITO) by the cooperation with lithography-etching process. Furthermore, an insulating layer 122 is vertically arranged at an intercrossing position with respect to parallel cathode electrode layers 121. The insulating layer 122 is made of insulating materials of silicon glue or silica (SiO₂) by the formation of screening or extrusion coating process. The insulating layer 122 is also overlapped with the cathode electrode layer 121 to form a projection. In addition, a gate electrode layer 123 of straight stripe shape is arranged on the space 124 formed between any two parallel stripes of cathode electrode layer 121. The gate electrode layer 123 overrides the insulating layer 122 and is parallel to the cathode electrode layer 121. As shown in the sectional view of FIG. 3, except for a transparent and coplanar structure formed on the plate surface of the cathode substrate 11 by the gate electrode layer 123 and the cathode electrode layer 121, both of which are vertically intercrossed by the insulating layer 122 as well, and between which a horizontal space 125 is arranged. The magnitude of the space 125 is kept between 20 μm and 80 μm. The gate electrode layer 123 is made of indium tin oxide (ITO) by the cooperation with lithography-etching process and is constructed as comb-shaped area together with the cathode electrode layer 121. Finally, parallel to the gate electrode layer 123, plural cathode electron emitting sources 126 are arranged at two sides of stripe-shaped cathode electrode layer 121. The cathode electron emitting source 126 is comprised of nano carbon tubes formed on the cathode electrode layer 121 by the electrophoresis or lithography-etching process. The thickness of cathode electron emitting source 126 is at least 10 μm or above. A specific horizontal distance is kept between the cathode electron emitting source 126 and the gate electrode layer 123 and is equal to the distance of the space 125 formed between the gate electrode layer 123 and the cathode electrode layer 121 adjacent thereto. Furthermore, the thickness of the cathode electrode layer 121 and the gate electrode layer 123 is below 500 nm.

The anode plate 2 is comprised of an anode substrate 21, which is constructed by transparent glass, and on which an anode unit 22 is arranged and is corresponded to the cathode unit 12. The anode unit 22 includes an electrode layer 221 and a fluorescent layer 222, which is arranged on the electrode layer 221 and is corresponded to the emitting direction of the cathode electron emitting source 126. At last, the spacers 3 are arranged between the cathode plate 1 and the anode plate 2 and are linearly surrounded the circumference of cathode unit 12 and anode unit 22 to create a vacuum situation. In addition, a reflecting layer is arranged at another plate surface of the cathode substrate 11 and is flatly pasted thereon.

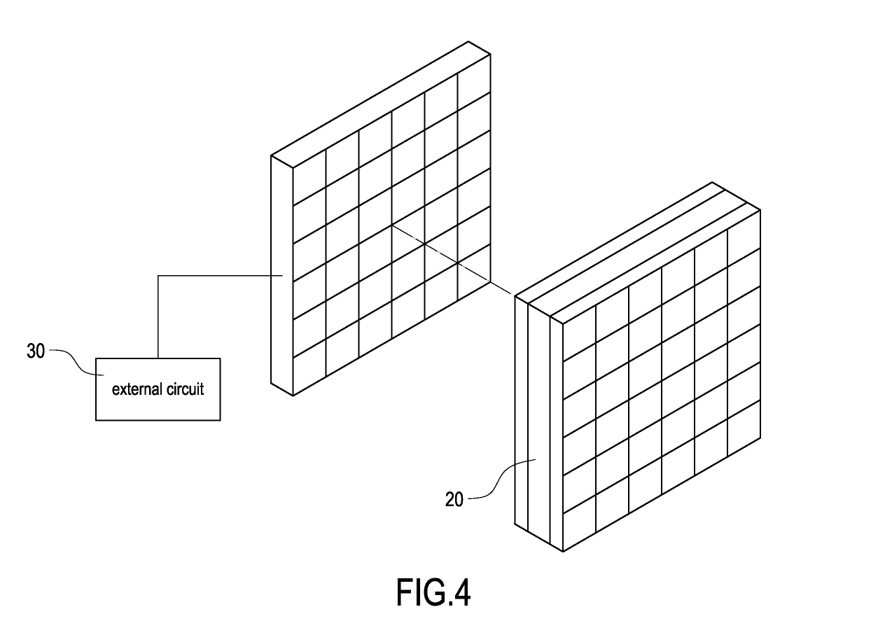

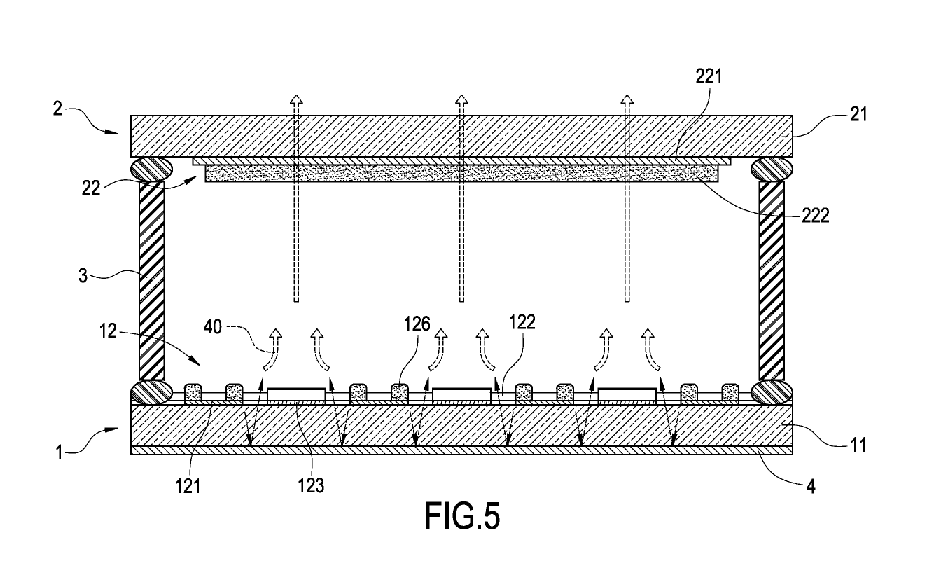

Please refer to FIG. 4 and FIG. 5, which respectively are an applying illustration and an operational illustration according to the present invention. As shown in FIG. 4, the backlight source structure according to the invention is corresponded to a liquid crystal panel 20. The backlight source structure is based upon the cathode unit 12 constructed on the cathode plate 1. The cathode unit 12 includes plural cathode electrode layers 121 and plural gate electrode layers 123 to construct a comb-shaped area, together with which plural cathode electron emitting sources 126 arranged on the cathode electron layer 121 and adjacent to two sides of the gate electrode layer 123 are formed into plural independent zones, together again with which the corresponding anode units 22 are further formed into a matrix-typed backlight source structure that independently controls the luminance of each corresponded pixel of the liquid crystal panel 20 through the control of an external circuit 30. An electric field is generated in the vacuum zone formed between the cathode plate 1 and the anode plate 2 by an external power source input from the external circuit, such that the cathode electron emitting sources 126 are excited to emit electron beam 40 impinging upon the fluorescent layer 222 to excite light source, which is transmitted out of the anode substrate 21, whereby the luminance needed by the pixel of the corresponded liquid crystal panel 20 is provided. In addition, after being excited by the fluorescent layer 222 and transmitted out of the cathode substrate 11, the light source is reflected by the reflecting layer 4 and finally is transmitted out of the anode substrate 21, whereby the luminance generated by the backlight source on the liquid crystal panel 20 is further enhanced.

Aforementioned structures are only preferable embodiments according to the present invention, being not used to limit its executing scope. Any equivalent variation and modification made according to appended claims is all covered by the claims claimed by the present invention.

What is claimed is:

1. A backlight source structure of field emission type applied to a liquid crystal display panel, the structure comprising:
an anode plate, which includes an anode substrate, on which an anode unit is arranged;
a cathode plate, which is connected in parallel and correspondingly to the anode plate and includes a cathode plate, on a plate surface of which a cathode unit is arranged, and the cathode unit corresponding to the anode unit is shown as a comb shape and further includes a cathode electrode layer and a gate electrode layer, both of which are coplanar on the cathode substrate, and at an intercrossing position with respect to both which an insulating layer is vertically overlapped to separate two layers; and
a spacer, which is arranged between the anode plate and the cathode plate and is linearly surrounded the anode unit and the cathode unit;
wherein plural independent areas are separated by the comb-typed cathode unit and are formed as a matrix-typed backlight source structure by the cooperation with the anode unit, whereby a light source needed by the corresponding liquid crystal display panel is independently provided.

2. The backlight source structure of field emission type according to claim 1, wherein another plate surface of the cathode substrate is arranged a reflecting layer.

3. The backlight source structure of field emission type according to claim 1, wherein the cathode electrode layer is shown as a comb shape.

4. The backlight source structure of field emission type according to claim 1, wherein the cathode electrode layer is made of indium tin oxide (ITO) by the lithography-etching process.

5. The backlight source structure of field emission type according to claim 1, wherein the gate electrode layer is shown as stripe shape.

6. The backlight source structure of field emission type according to claim 1, wherein the gate electrode layer is made of indium tin oxide (ITO) by a lithography-etching process.

7. The backlight source structure of field emission type according to claim 1, wherein the insulating layer is constituted by silicon glue or silica (SiO₂).

8. The backlight source structure of field emission type according to claim 1, wherein the insulating layer is formed by screening or extrusion coating process.

9. The backlight source structure of field emission type according to claim 1, wherein two sides of the gate electrode layer are adjacent to the cathode electrode layer.

10. The backlight source structure of field emission type according to claim 9, wherein a horizontal space is arranged between the gate electrode layer and the cathode electrode layer.

11. The backlight source structure of field emission type according to claim 1, wherein the cathode unit further includes plural cathode electron emitting sources, which are arranged at two sides of the cathode electrode layer.

12. The backlight source structure of field emission type according to claim 11, wherein a horizontal space is arranged between the cathode electron emitting source and the gate electrode layer adjacent thereto.

13. The backlight source structure of field emission type according to claim 12, wherein the magnitude of the space is between 20 μm and 80 μm.

14. The backlight source structure of field emission type according to claim 11, wherein the thickness of the cathode electron emitting source is at least 10 μm or above.

15. The backlight source structure of field emission type according to claim 11, wherein the cathode electron emitting source is comprised of nano carbon tubes.

16. The backlight source structure of field emission type according to claim 1, wherein the anode substrate is comprised of transparent glass.

17. The backlight source structure of field emission type according to claim 1, wherein the cathode substrate is comprised of transparent glass.

18. The backlight source structure of field emission type according to claim 1, wherein the anode unit further includes an anode layer and a fluorescent layer.
